(19) United States
(12) Patent Application Publication
(10) Pub. No.: US 2026/0245275 A1
(43) Pub. Date: Aug. 20, 2026

(54) IMAGE GENERATION SYSTEM, IMAGE GENERATION METHOD, AND RECORDING MEDIUM

(71) Applicant: NEC Corporation, Tokyo (JP)

(72) Inventors: Shimpaku KIYOMIYA, Tokyo (JP); Shinichi TOKUYAMA, Tokyo (JP)

(73) Assignee: NEC Corporation, Tokyo (JP)

(21) Appl. No.: 19/161,725

(22) PCT Filed: Mar. 14, 2023
(86) PCT No.: PCT/JP2023/009887

§ 371 Date: Sep. 3, 2025

(51) Int. Cl. G06T 11/60; G06Q 50/10

(52) U.S. Cl. CPC G06T 11/60; G06Q 50/10

(57) ABSTRACT

This image generation system includes an acquisition unit, a conversion unit, a generation unit, and an output unit. The acquisition unit acquires data pertaining to users' behaviors at a tourist facility. The conversion unit converts the data pertaining to the users' behaviors into a text representing the users' behaviors or an environment at the time of the behaviors on the basis of set rules. The generation unit generates an image on the basis of the text converted by the conversion unit by using a generation model by which an image pertaining to the tourist facility is generated on the basis of the text. The output unit outputs the generated image.

### TECHNICAL FIELD

The present disclosure relates to an image generation system and the like.

### BACKGROUND ART

In a theme park, a user may repeatedly use his/her favorite attraction, for example. Due to an event such as rain or waiting time, the user may not be able to enjoy a scheduled attraction as he/she wants. In order for such a repeatedly used user or a user who could not enjoy as expected to use the theme park again, for example, it may be necessary to obtain a sense of satisfaction for experience in the theme park. In order to obtain the user's satisfaction, for example, it is conceivable to provide content in which each user feels pleasure and surprise.

In an image printing system of PTL 1, a robot instructs a user to pose at a plurality of places in a tourist destination, thereby automatically imaging the user. The image printing system of PTL 1 generates an image for printing according to user's selection, for example.

### CITATION LIST

### Patent Literature

PTL 1: JP 2018-74281 A

### SUMMARY OF INVENTION

### Technical Problem

In the technique disclosed in PTL 1, it may be difficult to generate an image according to the user's behavior.

In order to solve the above problem, an object of the present disclosure is to provide an image generation system and the like capable of generating an image according to a user's behavior.

### Solution to Problem

In order to solve the above problem, an image generation system according to the present disclosure includes acquisition means for acquiring data regarding a behavior of a user in a tourist facility, conversion means for converting the data regarding the behavior of the user into a text representing the behavior of the user or an environment at the time of the behavior based on a set rule, generation means for generating an image based on the text converted by the conversion means by using a generation model that generates an image related to the tourist facility based on the text, and output means for outputting the generated image.

An image generation method according to the present disclosure acquires data regarding behavior of a user in a tourist facility, converts data regarding the behavior of the user into a text representing the behavior of the user or an environment at the time of the behavior based on a set rule, generates an image based on the converted text using a generation model that generates an image related to the tourist facility based on the text, and outputs the generated image.

A non-transitory recording medium according to the present disclosure records an image generation program for causing a computer to execute processing of acquiring data regarding a behavior of a user in a tourist facility, converting the data regarding the behavior of the user into a text representing the behavior of the user or an environment at the time of the behavior based on a set rule, generating an image based on the converted text by using a generation model that generates an image related to the tourist facility based on the text, and outputting the generated image.

### Advantageous Effects of Invention

According to the present disclosure, it is possible to generate an image according to a user's behavior.

### BRIEF DESCRIPTION OF DRAWINGS

FIG. 1 is a diagram illustrating an example of a configuration according to an example embodiment of the present disclosure.

FIG. 2 is a diagram illustrating an example of an image generated by an image generation system in the example embodiment of the present disclosure.

FIG. 3 is a diagram illustrating an example of an image generated by the image generation system in the example embodiment of the present disclosure.

FIG. 4 is a diagram illustrating an example of a configuration of the image generation system according to the example embodiment of the present disclosure.

FIG. 5 is a diagram illustrating an example of an image of a user according to the example embodiment of the present disclosure.

FIG. 6 is a diagram illustrating an example of an image generated by the image generation system in the example embodiment of the present disclosure.

FIG. 7 is a diagram illustrating an example of an image generated by the image generation system in the example embodiment of the present disclosure.

FIG. 8 is a diagram illustrating an example of an image generated by the image generation system in the example embodiment of the present disclosure.

FIG. 9 is a diagram illustrating an example of an operation flow of the image generation system according to the example embodiment of the present disclosure.

FIG. 10 is a diagram illustrating an example of a hardware configuration according to the example embodiment of the present disclosure.

### EXAMPLE EMBODIMENT

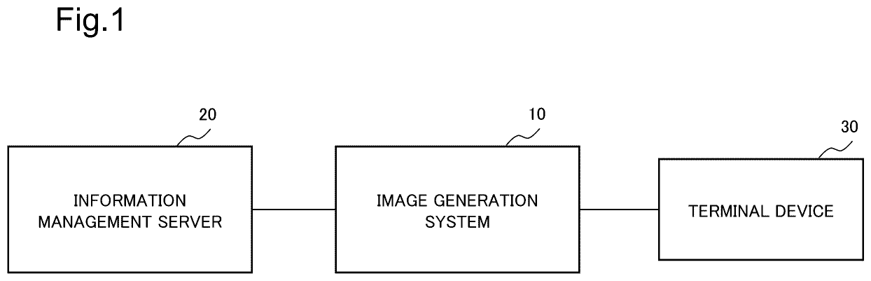

Example embodiments of the present disclosure will be described in detail with reference to the drawings. FIG. 1 is a diagram illustrating an example of a configuration of an image generation system. The image generation system includes an image generation system 10, an information management server 20, and a terminal device 30. The image generation system 10 is connected to the information management server 20 via a network. The image generation system 10 is connected to the terminal device 30 via the network. The terminal device 30 may be connected to the information management server 20 via the network. A plurality of the information management servers 20 and a plurality of the terminal devices 30 may be provided. The numbers of the information management servers 20 and the terminal devices 30 are appropriately set.

The image generation system 10 is, for example, a system that generates an image related to a tourist facility based on data regarding behavior of a user of the tourist facility. The image generation system 10 generates an image related to the tourist facility according to the data regarding the user's behavior of the tourist facility. That is, the image generation system 10 generates different images according to the data regarding the user's behavior of the tourist facility. The data regarding the user's behavior is, for example, behavior history data of the user in the tourist facility and data regarding the environment around the user in a period in which the user stays in the tourist facility. The behavior history data may include data of a purchase history of the user in the tourist facility.

The behavior history data is, for example, a history regarding an area and attraction used by the user, a parade watched, a show watched, a stay time, a waiting time, a product purchased by the user, and a service received by the user in the tourist facility. The area is each of areas obtained by dividing tourist facilities according to a predetermined criterion. The predetermined criterion is, for example, a criterion related to at least one of a theme set in the area, a type of attraction, a character present in the area, and a type of store. The predetermined criterion is not limited to the above. Using the area means, for example, that a user stays in the area in a tourist facility. Using the area means, for example, performing at least one of a walk, a landscape appreciation, a show appreciation, an interaction with a character, shopping, a meal, photographing, and a break in the area. The use of the area is not limited to the above.

The data regarding the environment around the user is, for example, weather information, temperature, wind speed, and the number of surrounding guests. The environment around the user is not limited to the above. The data regarding the user's behavior may include behavior history data of the user in at least one of an outward way to the tourist facility and a return way from the tourist facility. For example, in a case where the user goes to an airport nearest to the tourist facility by an airplane, a fact that the user has got on the airplane may be reflected in the generated image. The data regarding the user's behavior is not limited to the above.

The image related to the tourist facility is, for example, an image reflecting the feature of the tourist facility. The image related to the tourist facility is, for example, an image in which features of the tourist facility are illustrated. The feature of the tourist facility is, for example, at least one of an attraction, a character, an object, a location, a landscape, a building, a vehicle, a show, a product, and a food and drink to be provided unique to each tourist facility. The features of the tourist facility are not limited to the above. The image related to the tourist facility may be an image based on an actual image showing the features of the tourist facility.

The tourist facility is, for example, a theme park. In a case where the tourist facility is a theme park, the image generation system 10 generates an image in which characters and attractions of the theme park are depicted, for example. For example, the image generation system 10 generates an image in which a character and an attraction depicted in the image are changed according to data regarding behavior of a user of a theme park. The image generation system 10 changes, for example, the type of character and the type of attraction depicted in the image in accordance with data regarding the user's behavior of the theme park. For example, the image generation system 10 changes at least one of the number of characters, the posture of the character, the expression of the character, the belongings of the character, and the attachments of the character depicted in the image according to the data regarding the user's behavior in the theme park.

The tourist facility may be a commercial facility, an amusement park, a sports facility, a natural park, an occupational experience facility, a museum or an art gallery. The tourist facility may include a tourist destination. For example, the tourist facility may be a range in which a plurality of tourist spots is scattered in the tourist destination. The tourist facility is not limited to the above.

The image generation system 10 generates an image from a text according to the user's behavior and the environment at the time of the behavior by using, for example, a generation model that generates an image related to a tourist facility from the text. The image generation system 10 converts data regarding the user's behavior into text representing the user's behavior or environment at the time of the user's behavior based on rules. Then, the image generation system 10 generates an image using the generation model based on the text converted from the data regarding the user's behavior. At this time, the generated image is an image related to a tourist facility according to data regarding the user's behavior. The generated image is output to, for example, the terminal device 30 owned by the user of the tourist facility.

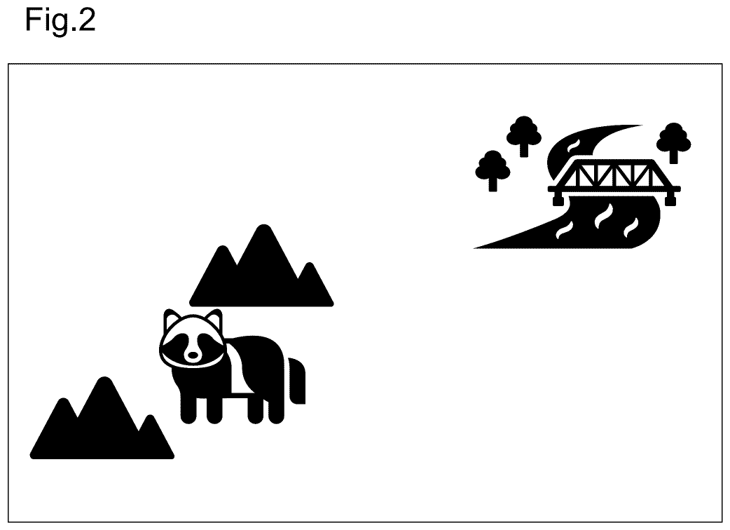

FIG. 2 illustrates an example of an image related to a tourist facility generated by the image generation system 10. An example of the image in FIG. 2 is an image related to a theme park with an animation using an animal as a character as a theme. In the example of the image of FIG. 2, for example, a user has used a mountain area and a river area, and thus illustrations of the mountains and the river are drawn in the image. In the example of the image of FIG. 2, an illustration of a raccoon dog, which is a character representing a forest area through which the user has passed, is drawn. The image generation system 10 converts, for example, data regarding behavior indicating that the user has used a mountain area and a river area into texts such as “mountain” and “river”. The image generation system 10 converts, for example, data regarding behavior indicating that the user has passed through the forest area into a text such as “raccoon dog” that is a character walking in the forest area. Then, the image generation system 10 generates an image as in the example of FIG. 2 based on the text converted from the data regarding the behavior. For example, the user can recall what he/she has experienced in the theme park by referring to the image as in the example of FIG. 2. For example, since a raccoon dog that is a character in the forest area is drawn between illustrations of mountains, the user can feel fun and surprise from the composition of the image.

The image generation system 10 changes, for example, at least one of the number of characters depicted in the image, the attachments of the characters, the belongings of the characters, and the background according to the surrounding environment of the user. For example, in a case where the area used by the user is congested, the image generation system 10 makes at least one of the number of characters and the type of characters depicted in the image larger than the normal time. For example, when it rains, the image generation system 10 generates an image representing rain with a background. For example, when it rains, the image generation system 10 generates an image in which a character wears a raincoat or an image in which a character carries an umbrella. How to reflect the surrounding environment of the user in the image is not limited to the above.

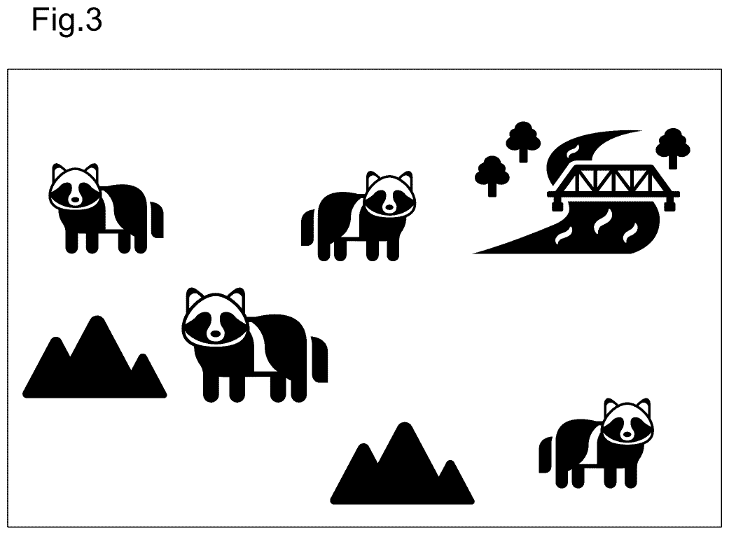

FIG. 3 illustrates an example of an image related to a tourist facility generated by the image generation system 10 in a case where the area used by the user is congested. In the example of the image of FIG. 3, similarly to the example of the image of FIG. 2, illustrations of mountains and a river are drawn in the image by using a mountain area and a river area by the user. In the example of the image of FIG. 3, an illustration of raccoon dogs, which are characters representing a forest area through which the user has passed, is drawn. In the example of the image of FIG. 3, for example, illustrations of a plurality of raccoon dogs are drawn in order to express that the forest area through which the user passed was congested. The image generation system 10 converts, for example, data regarding behavior indicating that the user has used a mountain area and a river area into texts such as “mountain” and “river”. The image generation system 10 converts, for example, data regarding behavior indicating that the user has passed through the forest area into a text such as “raccoon dog” that is a character walking in the forest area. Data regarding behavior indicating that many people have stayed in the forest area is converted into a text such as “mixed”. Then, the image generation system 10 generates an image like the example of the image in FIG. 3 based on the text converted from the data regarding the behavior.

For example, by referring to the image in which a plurality of illustrations of raccoon dogs are drawn as in the example of the image of FIG. 3, the user can feel fun and surprise from a composition of the image in which many raccoon dogs are drawn while thinking that it was crowded.

By generating the image related to the tourist facility used by the user in this manner, the user can obtain an image reflecting his/her own behavior in the tourist facility. That is, the user can obtain an image reflecting memories in the tourist facility. Randomness associated with the user's behavior occurs in the content of the image generated by reflecting the user's behavior. Also, by generating an image using a generation model, randomness may occur in the content of the generated image. Therefore, for example, even in a case where the user performs behavior similar to that in the past use in the tourist facility, the user can obtain an image different from the image obtained in the past. Therefore, the user who browses the image feels surprise and fun from the image, and the possibility that the user of the tourist facility uses the tourist facility again can be increased.

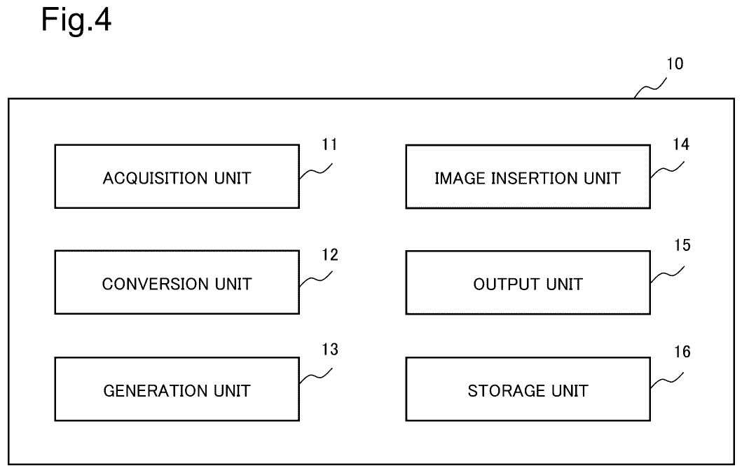

Here, an example of a specific configuration of the image generation system 10 will be described. FIG. 4 illustrates an example of a configuration of the image generation system 10.

The image generation system 10 includes an acquisition unit 11, a conversion unit 12, a generation unit 13, and an output unit 15 as a basic configuration. The image generation system 10 includes, for example, an inserted image generation unit 14 and a storage unit 16.

The acquisition unit 11 acquires data regarding the user's behavior in the tourist facility. The acquisition unit 11 acquires, for example, behavior history data of the user in the tourist facility and data regarding the surrounding environment at the time of the behavior as the data regarding the user's behavior. The acquisition unit 11 acquires, for example, data regarding the user's behavior in the tourist facility from the terminal device 30. For example, the acquisition unit 11 may acquire data regarding the user's behavior in the tourist facility from the terminal device 30 possessed by a companion of the user. For example, the acquisition unit 11 may acquire data regarding the user's behavior in the tourist facility from the information management server 20 connected via a network. The information management server 20 is, for example, a server that manages data regarding the user's behavior in a tourist facility.

The acquisition unit 11 may acquire information regarding user's preference for the generated image. The acquisition unit 11 may acquire information indicating timing for outputting an image. The acquisition unit 11 may acquire an image of the user used by the inserted image generation unit 14. For example, the acquisition unit 11 acquires, from the terminal device 30, information regarding preference of the user, information indicating timing of outputting an image, and an image of the user. For example, the acquisition unit 11 may acquire, via the information management server 20, information regarding preference of the user, information indicating timing of outputting an image, and an image reflecting the user.

The conversion unit 12 converts data regarding the user's behavior into text representing the user's behavior or the environment at the time of behavior based on the set rule. For example, the rule is set in such a way that data regarding the user's behavior is converted into a text on the area or attraction used by the user based on the user's behavior in the area or attraction in the tourist facility. The rule is set, for example, in such a way that data regarding the user's behavior is converted into a text regarding the environment around the user based on the environment around the user when the user stays in the area in the tourist facility or uses the attraction.

The rule indicates, for example, an item of data regarding the user's behavior to be converted. The item of the data regarding the user's behavior is, for example, information indicating what data the data relates to among the user's behavior history data and the data regarding the surrounding environment. The rule may include at least one of the number of texts after conversion and a selection criterion of text used for image generation. The selection criterion of the text to be used for image generation is, for example, a criterion related to at least one of weighting when selecting the text to be used for image generation, priority, and the number of selections for each item of data. The selection criterion of the text used for image generation is not limited to the above. The items included in the rule are not limited to the above.

The rule is set in such a way that, for example, at least one of an attraction, an area, and a name of a character related to the attraction in the tourist facility used by the user is included in the text converted from the data regarding the user's behavior.

The text representing the user's behavior is, for example, a text representing an area or attraction used by the user in the tourist facilities. The text representing the user's behavior may be a text representing both an area and an attraction used by the user in the tourist facility. The text representing the user's behavior is, for example, a text representing a show visited by the user. The text representing the user's behavior may be a text representing a length of a waiting time of the user. The text representing the user's behavior may be a text representing a character that the user has interacted with. The text representing the user's behavior may be a text representing at least one of a place where the user has had a meal, a content of the meal, a place where the user has purchased the product, and a content of the purchased product. The text representing the user's behavior may include a text representing a companion of the user. The text representing the user's behavior is not limited to the above. The text representing the environment at the time of the behavior is, for example, a text representing at least one of weather, a wind direction, a wind speed, temperature, humidity, a crowing status, and an operation state of the attraction when the user stays in the tourist facility. The text representing the environment at the time of the behavior is not limited to the above.

For example, the conversion unit 12 converts data regarding the user's behavior into a text according to a mode of reflecting the data in the image based on the set rule. For example, the conversion unit 12 converts data regarding the user's behavior into a text of each mode classification to be reflected in the image based on the set rule. The mode of reflecting the text in the image is, for example, a way of reflecting the text in each of the background and the foreground of the image. The mode of reflecting the text in the image may be, for example, a way of reflecting the text in the number of illustrations drawn in the image or a way of reflecting the text in at least one of the contents of the illustrations. The mode of reflection in the image is not limited to the above. The classification of the mode to be reflected in the image is, for example, each group in a case where the text is grouped according to a way to be reflected in the image. For example, the conversion unit 12 converts data regarding the user's behavior into a text for a background of the image and a text for a foreground of the image based on the set rule. For example, the conversion unit 12 may convert the data regarding the user's behavior into either the text for the background of the image or the text for the foreground of the image based on the set rule. At least one of the text for the background of the image and the text for the foreground of the image may be plural. For example, the conversion unit 12 may further convert the data regarding the user's behavior into a decorative text of the image based on the set rule. The decorative text of the image is reflected in, for example, a frame pattern added to the image. The classification according to the manner of reflection on the image is not limited to the above.

For example, the conversion unit 12 converts data regarding the behavior into a text in such a way that at least one of a name of the attraction, a name of the area, and the character is included in at least one of the text for the background and the text for the foreground. For example, the conversion unit 12 converts data indicating the attraction used by the user included in the data regarding the user's behavior into text for a background.

The data regarding the behavior and the text after the conversion are set in, for example, a table in which the data regarding the behavior and the text after the conversion are associated with each other. In a case where the data regarding behavior is numerical data, in the table, a level of a numerical value of the data regarding the behavior is associated with the converted text. The conversion unit 12 refers to the table to convert data regarding the user's behavior into a text.

The conversion unit 12 may convert data regarding the user's behavior into text using a conversion model. The conversion model is, for example, a training model generated by learning the relationship between data regarding behavior and text after conversion. The conversion model is generated by deep learning using a neural network, for example. Algorithm for generating the conversion model is not limited to the above. The conversion model is generated, for example, in a system external to the image generation system 10.

The conversion unit 12 may convert data regarding the user's behavior into text for each item of data regarding the user's behavior. For example, in a case where the tourist facility is a theme park, the conversion unit 12 converts data regarding the user's behavior into a text in such a way that at least one text from each of the area, the character, and the environment at the time of stay of the user is used for generation of an image, for example. The number of texts used for generating an image may be set for each classification of data regarding the user's behavior. The classification of the data regarding the user's behavior, a predetermined priority, and the number of texts used for generating images for each classification are set by, for example, an administrator of the image generation system 10.

The conversion unit 12 may convert data regarding the user's behavior into a text to be used for generating an image based on a predetermined priority. The predetermined priority is, for example, ranking of which item of data among data regarding the behaviors of a plurality of items is preferentially converted into a text. For example, in a case where the tourist facility is a theme park, the predetermined priority is, for example, information indicating which data of any item regarding the area, the character, and the environment at the time of stay of the user is to be preferentially converted into a text.

The predetermined priority is set in advance based on, for example, a policy of what behavior of the user is reflected in the image. For example, in a case where the area visited by the user is reflected in the image, an order in which the history data of the used area among the data regarding the user's behavior is converted into the text regarding the area of the user and the character in the area is set to be higher than data of the other items. For example, the conversion unit 12 converts data regarding behavior into a text in such a way that a predetermined number of texts is converted from data regarding the behavior based on the predetermined priority. The predetermined number is set to, for example, a value at which the generated image becomes an image that is easily accepted by the user. The predetermined priority and the predetermined number are set by, for example, an administrator of the image generation system 10. The predetermined priority and the predetermined number may be set by the user. The predetermined number may be randomly set for each generation of an image.

The conversion unit 12 may select a hierarchy from the hierarchized text and convert the data regarding the user's behavior into a text included in the selected hierarchy. The hierarchization is set, for example, in such a way that the included text indicates a more detailed target from a higher hierarchy to a lower hierarchy. For example, in a theme park based on a theme of nature, hierarchization is performed in such a way that a text related to an area is included in an upper hierarchy, a text related to classification of organisms present in the area is included in a middle hierarchy, and a text representing specific names of organisms is included in a lower hierarchy. For example, as the user stays in the area longer, the converter 12 converts the data regarding the behavior into the text of the lower layer. With conversion into the text in this manner, it is possible to generate an image reflecting the area in which the user is interested in more detail.

The conversion unit 12 may convert the data regarding the user's behavior into a text used for generating the image based on predetermined weighting. The predetermined weight is, for example, an index used at the time of selecting an item of data to be converted into a text among data of a plurality of items. The predetermined weighting means, for example, weighting each item of data regarding behavior. For example, the conversion unit 12 converts data regarding the behavior having a larger weight than that of other items into a text to be used for generating an image based on predetermined weighting. For example, the conversion unit 12 performs weighting in such a way that the weight of data regarding the behavior in an area with a long stay time increases. With performance of such weighting, for example, an area having a long stay time is easily reflected in the image. The conversion unit 12 may perform weighting in such a way that the weight of data of an item preferred by the user increases. For example, the conversion unit 12 performs weighting in such a way that the weight of data regarding the behavior in one of an area having a long stay time and a small value of attraction becomes large. The predetermined weighting criterion is not limited to the above. For example, the conversion unit 12 converts data of an item having a predetermined weight equal to or more than a criterion into a text. For example, the conversion unit 12 may convert data of items having a predetermined weight value from a top to a predetermined number into a text. The predetermined weighting criterion and the predetermined number are set by, for example, an operator of the image generation system 10, an operator of a tourist facility, or a user.

The conversion unit 12 may convert the behavior data regarding at least one of the timing of using the tourist facility, the predetermined area used in the tourist facility, and the predetermined attraction used in the tourist facility into a text. For example, in a case where a special image for using a specific attraction is provided during a campaign period, the conversion unit 12 converts, for example, a special image indicating a predetermined area and use of a predetermined attraction into a text that can be generated. For example, in a case where a special image is provided during a period of a predetermined custom, a text representing the predetermined custom may be included in the text after conversion. For example, the converted text may include a text representing a new year. In this way, for example, an image is generated by converting into a text capable of generating an image according to a period, and therefore the user can enjoy using the tourist facility for each period.

The conversion unit 12 may convert data regarding the user's behavior into a text according to the attribute of the user. For example, the conversion unit 12 may convert data regarding user's behavior into a text in such a way that an image different from images of other users is generated for a user whose number of times of use in a year is equal to or more than a criterion number of times. In this way, for example, an image is generated by converting into a text capable of generating an image according to the number of times of use, and therefore the number of times of use of the tourist facility can be increased. The conversion unit 12 may convert data regarding the user's behavior into a text in such a way that different images for adults and children are generated. For example, when generating an image for a user whose age is less than a criterion, the conversion unit 12 converts data regarding the user's behavior into a text in such a way that more characters are drawn in the image than in the case of the user whose age is equal to or more than the criterion. In this way, an image is generated by converting into a text capable of generating an image according to age, thereby making it possible to obtain a sense of satisfaction from users in a wide range of age groups, which can lead to use of tourist facilities in a group.

In a case where the image generated by the generation unit 13 is output, the conversion unit 12 may convert data regarding the user's behavior performed after a time point at which the image is output into a text representing the user's behavior or the environment at the time of the behavior. In a case where an image for the same user is output, the conversion unit 12 converts data regarding behavior after the time point at which the image is output into a text representing the user's behavior or the environment at the time of the behavior. That is, the conversion unit 12 resets the history of the data regarding the behavior, and converts the data regarding the behavior acquired after the reset time point into a text representing the user's behavior or the environment at the time of the behavior. As described above, the data regarding the user's behavior after the time point at which the image is output is converted into the text, thereby making it possible to generate an image that is not similar to the output image when the generation unit 13 generates the image again.

In a case where the image generated by the generation unit 13 is output, the conversion unit 12 may convert data regarding the user's behavior for each predetermined time zone into a text representing the user's behavior or the environment at the time of the behavior. For example, the conversion unit 12 converts each of data regarding the user's behavior in a morning time zone, the data regarding the user's behavior in an afternoon time zone, and data regarding the user's behavior in a night time zone into a text representing the user's behavior or the environment at the time of the behavior. In this manner, the data regarding the user's behavior is converted into a text representing the user's behavior or the environment at the time of the behavior for each time zone, and thus an image according to the time zone can be generated. The time zone of a font is set by, for example, an operator of the image generation system 10, an operator of a tourist facility, or a user. As described above, the period of the data regarding the behavior for converting into the text is changed every time the image is generated, and thus the user can obtain an image having a difference every time the image is acquired, for example. Therefore, the user can feel fun from each image, for example.

The generation unit 13 generates an image based on the text converted by the conversion unit 12, using a generation model that generates an image related to the tourist facility based on the text. The generation unit 13 generates an image from the text converted by the conversion unit 12 using, for example, a generation model that generates an image related to a tourist facility from the text. For example, the generation unit 13 generates an image related to the tourist facility using the generation model based on the text converted from the data regarding the user's behavior by the conversion unit 12. For example, the generation model generates an image related to the tourist facility by inputting a text for the image related to the tourist facility. The generation model generates, for example, an image in which a feature of a tourist facility is drawn as an illustration. The generation model generates, for example, an image that changes according to data regarding the user's behavior while reflecting the feature of the tourist facility. For example, the generation model may generate an image based on an actual image showing the features of the tourist facility.

The generation model is a machine learning model that generates an image from a text. The generation model is generated using, for example, a generative adversarial network (GAN). The generation model is generated by using an image related to a tourist facility, information related to a place drawn in the image, and a text associated with the image as training data. The image related to the tourist facility is, for example, an image in which a feature of the tourist facility is drawn as an illustration. The image related to the tourist facility may be a photograph showing a feature of the tourist facility. The generation model may be generated by relearning a machine-learned learning model that generates an image from text, using training data for each tourist facility. A training algorithm used for generating the generation model is not limited to the GAN.

For example, in a case where the tourist facility is a theme park, the image related to the tourist facility used as the training data is, for example, an image in which at least one of a character of the theme park or an attraction of the theme park is drawn. The text is associated with the image. The information regarding the place depicted in the image is the name of an attraction or an area in the theme park. The information regarding the place drawn in the image may be the name of a character drawn in the image. The text associated with the image is, for example, text describing a feature of the image. The text describing the features of the image is a text associated with the image in a case where data regarding the behavior is converted into a text. The text describing the feature of the image is, for example, a text “crowded” in a case where the area or attraction used by the user is congested. In this case, for example, a plurality of characters is drawn in the image with which the text is associated. A plurality of texts may be associated with the image.

The generation unit 13 generates an image related to the tourist facility using the generation model based on the text converted by the conversion unit 12 at a predetermined timing based on the user's behavior, for example. For example, the generation unit 13 generates an image related to the tourist facility when the user exits from the tourist facility. The generation unit 13 may generate the image related to the tourist facility when the stay time or the waiting time of the user at the same place is equal to or longer than a criterion. The generation unit 13 may generate an image related to a tourist facility when the user is in a dining room or a rest area. A predetermined timing is set by the operator of the image generation system 10, the operator of the tourist facility, or the user.

The generation unit 13 may generate an image related to a tourist facility at a predetermined time. The generation unit 13 may generate images related to tourist facilities at a predetermined time interval. The predetermined time and the predetermined time interval are set by the operator of the image generation system 10, the operator of the tourist facility, or the user. The timing at which the generation unit 13 generates the image related to the tourist facility is not limited to the above.

For example, the inserted image generation unit 14 generates an image in which a user-based image is inserted into an image generated from text by the generation model. For example, the inserted image generation unit 14 illustrates the image of the user and inserts the illustrated image into an image generated by the generation model. For example, the inserted image generation unit 14 generates an image of an illustration reflecting the feature of a face of the user appearing in the image. Then, the inserted image generation unit 14 inserts the generated image of the illustration into the image generated by the generation model. The inserted image generation unit 14 may generate an image of an illustration reflecting the features of the posture or pose of the user appearing in the image and insert the image into the image generated by the generation model.

For example, the inserted image generation unit 14 generates an image of an illustration reflecting features of the face, posture, or pose of the user based on a character related to an attraction used by the user in the tourist facility. For example, the inserted image generation unit 14 inserts the illustrated image of the user into the vicinity of the character drawn in the image generated by the generation model. For example, the inserted image generation unit 14 generates an image in which the illustrated user appears to be interacting with a character drawn in the image generated by the generation model. For example, the inserted image generation unit 14 may insert the illustrated image of the user near the attraction drawn in the image generated by the generation model. The position where the image in which the image of the user is illustrated is inserted is not limited to the above.

For example, the inserted image generation unit 14 generates an image in which a user-based image is inserted into an image generated based on the text by the generation model by using the image insertion model. For example, the inserted image generation unit 14 generates an image in which the user-based image is inserted into an image generated from text by the generation model by using the image insertion model. The image insertion model is a machine learning model that illustrates an image of a user and inserts the illustrated image into an image generated by a generation model. The image insertion model is generated using, for example, the GAN. The image insertion model is generated by using an image in which an illustrated user is inserted and an image of the user as training data. The training algorithm used to generate the image insertion model is not limited to the GAN.

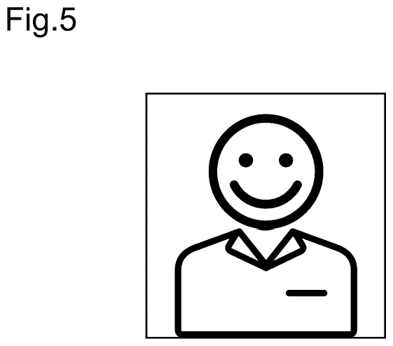

FIG. 5 is a diagram illustrating an example of an image showing the face of the user to be inserted into the image generated by the generation unit 13. An example of the image in FIG. 5 is an image in which an upper body of the user is imaged by the imaging device included in the terminal device 30, for example.

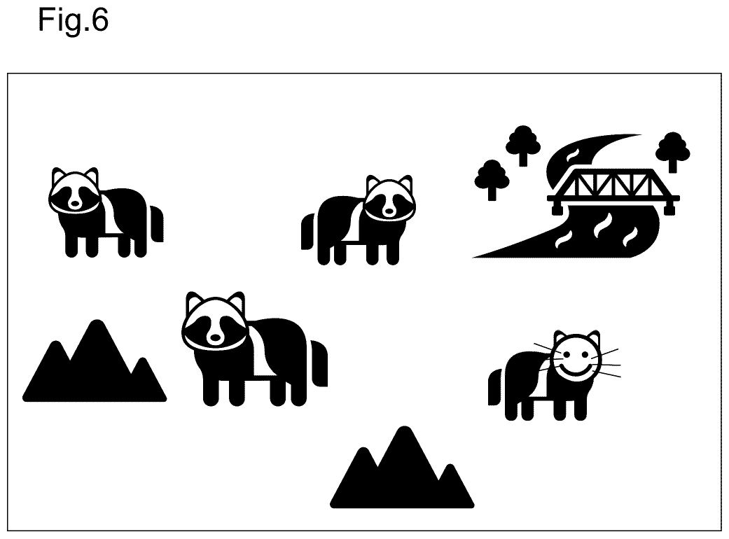

FIG. 6 illustrates an example of an image in which a user of the example of the image of FIG. 5 is illustrated and inserted into the image generated by the generation unit 13. In the example of the image of FIG. 6, the user is drawn as a raccoon dog by illustrating the facial features of the user in an image similar to the image illustrated in the example of FIG. 3. An image as in the example of the image of FIG. 6 is generated based on the image of the user, and thus the image generation system 10 can generate an image that makes it easier for the user to think back about what the user has experienced in the tourist facility, for example.

The output unit 15 outputs the generated image. The generated image is, for example, at least one of an image generated by the generation model and an image inserted by the image insertion model. The output unit 15 outputs the generated image to the terminal device 30, for example. The output unit 15 may output the generated image to a management server that manages information regarding the user of the tourist facility. The output unit 15 may output the generated image to a display device (not illustrated) connected to the image generation system 10.

The output unit 15 outputs the generated image, for example, at a timing at which the user's behavior performs a predetermined behavior. The output unit 15 outputs the generated image, for example, at a timing when the user leaves an exit of the tourist facility.

The output unit 15 outputs the generated image at a timing at which a predetermined time has elapsed from a time point at which the user leaves the exit of the tourist facility. The predetermined time is set based on, for example, a time at which the user is assumed to be on the way home from the tourist facility. The predetermined time may be set in such a way that the timing of outputting the image is on or after the next day when the user uses the tourist facility. For example, the predetermined time is set such that the timing of outputting the image is the next day, and thus the user who browses the image can remember the behavior of the previous day. The predetermined time is set such that the timing of outputting the image is after a lapse of a long time from the use of the tourist facility, thereby making it possible to encourage the user to reuse the tourist facility. For example, the output unit 15 outputs the generated image 3 months after the user uses the tourist facility. The predetermined time is not limited to the above.

The output unit 15 may output the generated image at the timing of returning home from the tourist facility. The output unit 15 determines whether the user has come home based on, for example, position information of the terminal device 30 owned by the user and registration information of the user.

The output unit 15 may output the generated image, for example, at a timing at which the user is in a dining room in the tourist facility. The output unit 15 may output the generated image in a case where the time during which the user waits for use of the attraction exceeds a criterion. For example, the output unit 15 determines the position of the user or the waiting time for using the attraction based on the position information of the terminal device 30 owned by the user.

The output unit 15 may output the generated image in response to a request of the user. The output unit 15 may output the generated image at a predetermined time. The predetermined time is set by, for example, an operator of the image generation system 10, an operator of a tourist facility, or a user. The output unit 15 may output images generated at predetermined time intervals since the user enters the tourist facility until the user exits. The predetermined time interval is set by, for example, an operator of the image generation system 10, an operator of a tourist facility, or a user.

The output unit 15 may output the generated image to a manufacturing system of products related to the tourist facility. The product related to the tourist facility is, for example, a product specific to the tourist facility sold at a store in the tourist facility. The product related to the tourist facility may be a product to be sent to the user at a later date. For example, the output unit 15 outputs the generated image to a printing system that prints the generated image on a T-shirt of a tourist facility. The output unit 15 may output the generated image to a creation system that creates a photo frame using the generated image. An output destination of the generated image is not limited to the above.

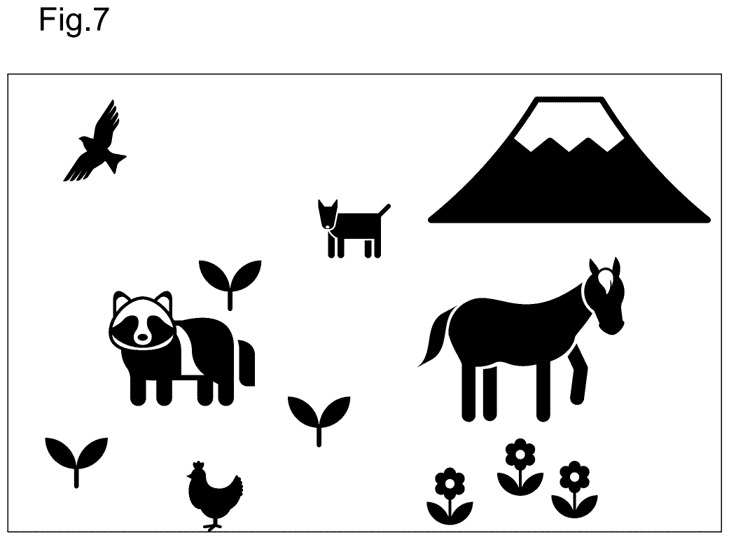

FIG. 7 illustrates an example of a diagram image related to a tourist facility generated by the image generation system 10. An example of the image in FIG. 7 is an image related to a theme park with an animation using an animal as a character as in FIG. 2. The example of the image in FIG. 7 is, for example, an example of an image generated in a case where a grassland area, a forest area, a mountain area, and a village area in a theme park are used.

For example, the conversion unit 12 converts data regarding the used area included in the data regarding the user's behavior into texts such as “grassland”, “forest”, “mountain”, and “village”. The conversion unit 12 converts, for example, data of the number of used areas included in the data regarding the user's behavior into a text such as “many areas”. Then, for example, the generation unit 13 generates an image like the example of the image in FIG. 7 using the generation model based on the text converted by the conversion unit 12.

In the example of the image of FIG. 7, for example, a grassland at a foot of the mountain is drawn as the scenery of a grassland area based on “grassland” converted from the data regarding the behavior by using the grassland area. In the example of the image of FIG. 7, a plurality of characters is drawn based on “grassland”, “forest”, “mountain”, “village”, and “many areas” converted from data regarding behavior by the user visiting a plurality of areas. In the example of the image of FIG. 7, characters of a horse in the grassland area, a raccoon dog in the forest area, a falcon in the mountain area, and a dog and a chicken in a village area are drawn. An image as in the example of the image of FIG. 7 is generated such that the image generation system 10 can generate an image that makes it easy for the user to think back that he/she has used many areas, for example.

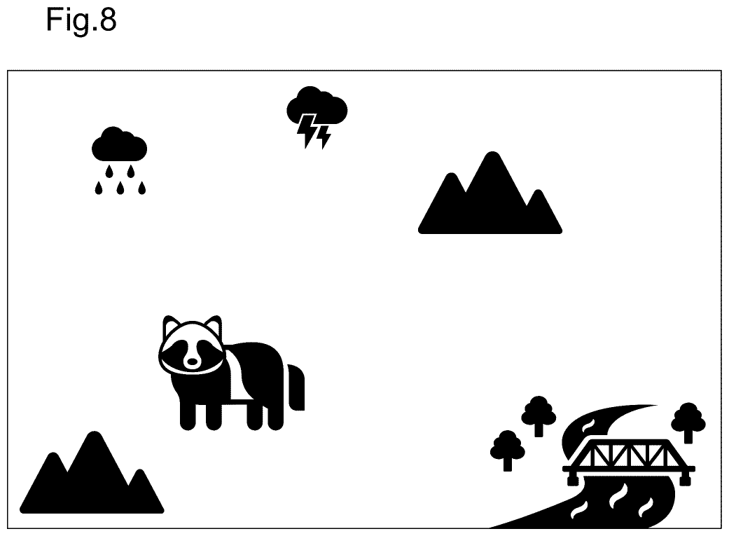

FIG. 8 is an example of an image further reflecting weather information in the example of the image of FIG. 2. The example of the image of FIG. 8 is an image in a case where the user uses a mountain area and a river area after passing through a forest area, similarly to the example of the image of FIG. 2. An example of the image of FIG. 8 is an image in a case where a thunderstorm suddenly occurs while the user uses a theme park.

For example, the conversion unit 12 converts data regarding the used area included in the data regarding the user's behavior into texts such as “forest”, “mountain”, and “river”. The conversion unit 12 converts, for example, data of thunderstorm included in the data regarding the user's behavior into texts such as “sudden rain” and “thunder”.

Then, for example, the generation unit 13 generates an image like the example of the image in FIG. 8 using the generation model based on the text converted by the conversion unit 12.

In the example of the image of FIG. 8, illustrations of mountains and a river and illustration of a raccoon dog are drawn based on “forests”, “mountains”, and “river” converted from the data of the used area. In the example of the image of FIG. 8, for example, a thundercloud and a rain cloud are drawn in a part of the image based on “sudden rain” and “thunder” converted from weather data. An image as in the example of the image of FIG. 8 is generated such that the image generation system 10 can generate an image that makes it easy for the user to remember an unexpected event such as a sudden rain fall, for example.

The storage unit 16 stores, for example, data used for generating an image related to a tourist facility. The storage unit 16 stores, for example, a rule for converting data regarding the user's behavior into a text, and the storage unit 16 stores, for example, a table in which data regarding the user's behavior is associated with a text. The storage unit 16 stores, for example, the generation model. The storage unit 16 stores, for example, a conversion model. The storage unit 16 stores, for example, the inserted image generation model. The generation model, the conversion model, and the inserted image generation model may be stored in a storage means other than the storage unit 16.

The information management server 20 manages, for example, information regarding the environment in the tourist facility. For example, the information management server 20 manages information regarding the environment in the tourist facility for each date and time. The information regarding the environment in the tourist facility is, for example, information on one or more items among weather information, the number of entering people, the number of staying people in each area, the density of staying users in each area, the average stay time in each area, the number of users of the attraction, and the average waiting time of the attraction. The information regarding the environment in the tourist facility is not limited to the above. The information regarding the environment in the tourist facility is used, for example, in the conversion unit 12 of the image generation system 10 as data regarding the surrounding environment among the data regarding the user's behavior. For example, the information management server 20 outputs information regarding the environment in the tourist facility to the acquisition unit 11 of the image generation system 10 in response to a request from the image generation system 10.

The information management server 20 may manage the behavior history data of the user in the tourist facility. For example, the information management server 20 acquires the behavior history data of the user from an entrance/exit gate, an entrance/exit gate of each attraction, a monitoring system in the tourist facility, the terminal device 30 possessed by the user, a point of sales (POS) system of a store, and a POS system of a dining room. For example, the information management server 20 may acquire the behavior history data of the user from a system other than the above. The behavior history data of the user in the tourist facility is used as, for example, data regarding the user's behavior in the conversion unit 12 of the image generation system 10.

The information management server 20 may manage the image generated by the image generation system 10. For example, the information management server 20 acquires the image generated by the image generation system 10 from the output unit 15 of the image generation system 10. The information management server 20 may output to the terminal device 30 an image in response to a request from the terminal device 30.

The terminal device 30 acquires, for example, an image generated by the image generation system 10. Then, the terminal device 30 outputs the acquired image to a display device (not illustrated). The terminal device 30 records, for example, data regarding the user's behavior. Then, the terminal device 30 outputs the recorded data regarding the user's behavior to the image generation system 10, for example. The terminal device 30 records data regarding the user's behavior by, for example, an application program for a tourist facility. The terminal device 30 records, for example, at least one of an entrance time of the user to the tourist facility, an area in the used tourist facility, a stay time in each area, an attraction used, a stay time in each attraction, a waiting time of the attraction, and a purchased product. In a case where the position of the terminal device 30 is used as the position information of the user, the terminal device 30 specifies the position of the terminal device 30 using, for example, a global navigation satellite system (GNSS).

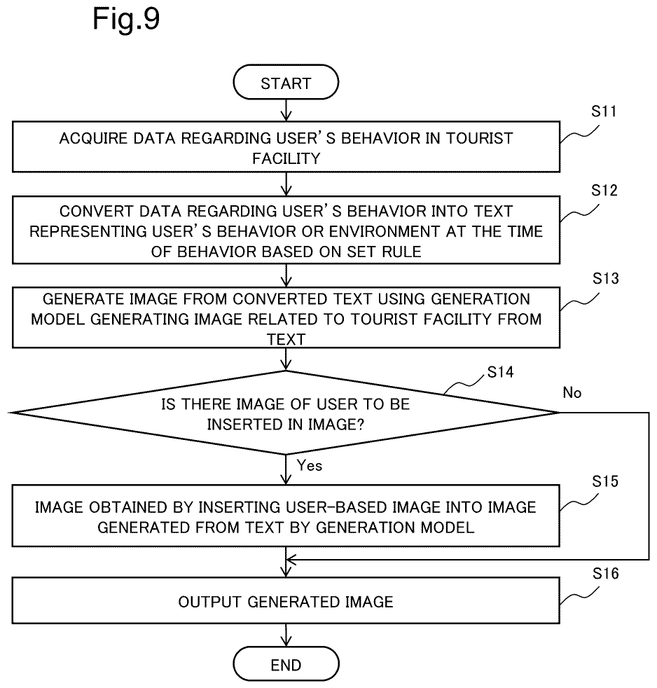

An operation when the image generation system 10 generates an image related to a tourist facility will be described. FIG. 9 illustrates an example of an operation flow when the image generation system 10 generates an image related to a tourist facility.

The acquisition unit 11 acquires data regarding the user's behavior in the tourist facility (step S11). The acquisition unit 11 acquires, for example, data regarding the user's behavior in the tourist facility from the terminal device 30.

When the data regarding the user's behavior is acquired, the conversion unit 12 converts the data regarding the user's behavior into a text representing the user's behavior or the environment at the time of the behavior based on the set rule (step S12).

When the data regarding the user's behavior is converted into the text, the generation unit 13 generates an image from the text converted by the conversion unit 12 using the generation model that generates the image related to the tourist facility from the text (step S13).

In a case where there is an image of the user to be inserted into the image when the image is generated from the text (Yes in step S14), the inserted image generation unit 14 generates an image in which the user-based image is inserted into the image generated from the text by the generation model (step S15).

When the image in which the user-based image is inserted is generated, the output unit 15 outputs the image generated by the inserted image generation unit 14 (step S16). The output unit 15 outputs the image generated by the inserted image generation unit 14 to the terminal device 30, for example.

In a case where there is no image of the user to be inserted into the image when the image is generated from the text (No in step S14), the output unit 15 outputs the image generated by the generation unit 13 (step S16). The output unit 15 outputs the image generated by the generation unit 13 to the terminal device 30, for example.

The image generation system 10 converts data regarding the user's behavior in the tourist facility into a text representing the user's behavior or the environment at the time of the behavior based on the set rule. The image generation system 10 generates an image related to the tourist facility from the text representing the user's behavior or the environment at the time of the behavior by using the generation model. In this way, the image reflecting the behavior or the environment at the time of the user's behavior in the tourist facility is generated such that the image generation system 10 can generate the image reflecting the experience of the user in the tourist facility. Therefore, for example, even in a case where the user uses the same tourist facility a plurality of times, the image generation system 10 can generate different images for each use. For example, even in a case where the user uses the same attraction in the tourist facility, the image generation system 10 can generate different images according to the environment at the time of use for each use of the attraction by the user. Therefore, the image generation system 10 can generate an image according to the user's behavior. The image generation system 10 generates an image according to the user's behavior so as to generate an image that makes the user feel surprised and fresh.

In a case where an image based on an image reflecting the user is inserted into an image generated by the generation model, the image generation system 10 generates an image of the user on an image reflecting an environment when the user uses the attraction, for example. The image generation system 10 can generate such an image to generate an image that can recall what the user has experienced. Therefore, the image generation system 10 can generate, for example, an image with which the user can obtain more satisfaction.

Each processing in the image generation system 10 may be executed in a distributed manner in a plurality of information processing apparatuses connected via a network. For example, the processing in the conversion unit 12 and the processing in the generation unit 13 and the inserted image generation unit 14 may be performed in different information processing apparatuses. For example, the processing in the conversion unit 12 and the generation unit 13 and the processing in the inserted image generation unit 14 may be performed in another information processing apparatus. Which of the plurality of information processing apparatuses performs each processing in the image generation system 10 can be appropriately set.

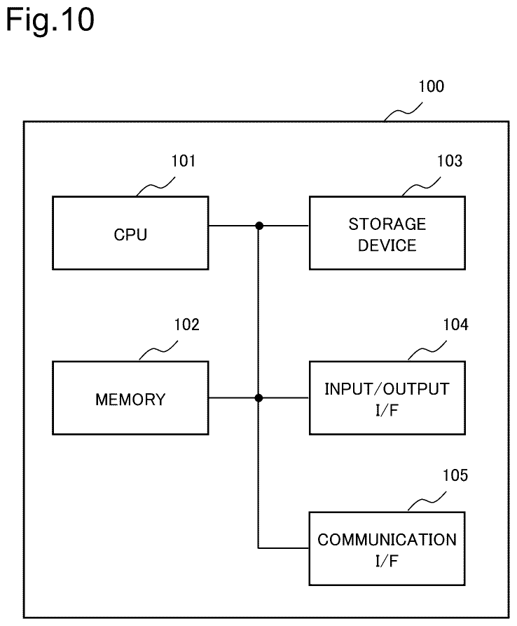

Each processing in the image generation system 10 can be achieved by executing a computer program on a computer. FIG. 10 illustrates an example of a configuration of a computer 100 that executes a computer program for performing each processing in the image generation system 10. The computer 100 includes a central processing unit (CPU) 101, a memory 102, a storage device 103, an input/output interface (I/F) 104, and a communication I/F 105.

The CPU 101 reads and executes a computer program for executing each processing from the storage device 103. The CPU 101 may be configured by a combination of a plurality of CPUs. The CPU 101 may be configured by a combination of a CPU and another type of processor. For example, the CPU 101 may be configured by a combination of a CPU and a graphics processing unit (GPU). The memory 102 includes a dynamic random access memory (DRAM) or the like, and temporarily stores a computer program executed by the CPU 101 and data being processed. The storage device 103 stores the computer program executed by the CPU 101. The storage device 103 includes, for example, a non-volatile semiconductor storage device. The storage device 103 may include another storage device such as a hard disk drive. The input/output I/F 104 is an interface that receives an input from an operator and outputs display data and the like. The communication I/F 105 is an interface that transmits and receives data to and from the information management server 20, the terminal device 30, and other information processing devices. The terminal device 30 may have a configuration similar to that of the computer 100.

The computer program used for executing each processing can also be distributed by being stored in a computer-readable recording medium that non-transiently records data. The recording medium can include, for example, a magnetic tape for data recording or a magnetic disk such as a hard disk. The recording medium may include an optical disk such as a compact disc read only memory (CD-ROM). A non-volatile semiconductor storage device may be used as the recording medium.

Some or all of the above example embodiments may also be described as the following Supplementary Notes, but are not limited to the following.

### [Supplementary Note 1]

An image generation system including: acquisition means for acquiring data regarding a behavior of a user in a tourist facility; conversion means for converting the data regarding the behavior of the user into a text representing the behavior of the user or an environment at the time of the behavior based on a set rule; generation means for generating an image based on the text converted by the conversion means by using a generation model that generates an image related to the tourist facility based on the text; and output means for outputting the generated image.

### [Supplementary Note 2]

The image generation system according to Supplementary Note 1, in which the rule is a rule in which the data regarding the behavior of the user is converted into a text related to an area or attraction used by the user based on the behavior of the user in the area or attraction in the tourist facility.

### [Supplementary Note 3]

The image generation system according to Supplementary Note 1 or 2, in which the conversion means converts data regarding the behavior of the user into a text according to a mode of reflecting the data in an image based on a set rule.

### [Supplementary Note 4]

The image generation system according to any one of Supplementary Notes 1 to 3, in which the output means outputs an image generated at a timing at which the user performs a predetermined behavior.

### [Supplementary Note 5]

The image generation system according to any one of Supplementary Notes 1 to 4, in which the conversion means converts the data regarding the behavior of the user into a text used for generating the image based on weighting indicating priority of reflecting the data in the image.

[supplementary Note 6]

The image generation system according to any one of Supplementary Notes 1 to 5, further including inserted image generation means for generating an image in which an image based on a face of the user is inserted into an image generated by the generation model based on the text.

### [Supplementary Note 7]

The image generation system according to any one of Supplementary Notes 1 to 6, in which the conversion means converts behavior data regarding at least one of a timing of using the tourist facility, a predetermined area used in the tourist facility, and a predetermined attraction used in the tourist facility into a text.

### [Supplementary Note 8]

The image generation system according to any one of Supplementary Notes 1 to 7, in which the tourist facility is a theme park, and the generation model generates an image based on at least one of an area of a theme park, an attraction, and a character.

### [Supplementary Note 9]

The image generation system according to any one of Supplementary Notes 1 to 8, in which in a case where the image is output, the conversion means converts data regarding behavior performed after a time point at which the image is output into a text representing the behavior of the user or an environment at the time of the behavior.

### [Supplementary Note 10]

The image generation system according to any one of Supplementary Notes 1 to 8, in which the output means outputs the generated image to a manufacturing system of a product related to the tourist facility.

### [Supplementary Note 11]

An image generation method including:
acquiring data regarding behavior of a user in a tourist facility;
converting data regarding the behavior of the user into a text representing the behavior of the user or an environment at the time of the behavior based on a set rule;
generating an image based on the converted text using a generation model that generates an image related to the tourist facility based on the text; and
outputting the generated image.

### [Supplementary Note 12]

A non-transitory recording medium recording an image generation program for causing a computer to execute processing of:
acquiring data regarding a behavior of a user in a tourist facility;
converting the data regarding the behavior of the user into a text representing the behavior of the user or an environment at the time of the behavior based on a set rule;
generating an image based on the converted text by using a generation model that generates an image related to the tourist facility based on the text; and
outputting the generated image.

The present disclosure has been described above by taking the above-described example embodiment as an example. However, the present disclosure is not limited to the above-described example embodiments. In other words, the present disclosure can be applied in various aspects those of ordinary skill in the art can understand within the scope of the present disclosure.

### REFERENCE SIGNS LIST

10 Image generation system
11 Acquisition unit
12 Conversion unit
13 Generation unit
14 Inserted image generation unit
15 Output unit
16 Storage unit
20 Information management server
30 Terminal device
100 Computer
101 CPU
102 Memory
103 Storage device
104 Input/output I/F
105 Communication I/F

What is claimed is:

1. An image generation system comprising:
at least one memory storing instructions; and
at least one processor configured to access the at least one memory and execute the instructions to:
acquire data regarding a behavior of a user in a tourist facility;
convert the data regarding the behavior of the user into a text representing the behavior of the user or an environment at the time of the behavior based on a set rule;
generate an image based on the text converted by the conversion means by using a generation model that generates an image related to the tourist facility based on the text; and
output the generated image.

2. The image generation system according to claim 1, wherein the rule is a rule in which the data regarding the behavior of the user is converted into a text related to an area or attraction used by the user based on the behavior of the user in the area or attraction in the tourist facility.

3. The image generation system according to claim 1, wherein the at least one processor is further configured to execute the instructions to: converts convert data regarding the behavior of the user into a text according to a mode of reflecting the data in an image based on a set rule.

4. The image generation system according to claim 1, wherein
the at least one processor is further configured to execute the instructions to:
the output means outputs an image generated at a timing at which the user performs a predetermined behavior.

5. The image generation system according to claim 1, wherein
the at least one processor is further configured to execute the instructions to:
convert the data regarding the behavior of the user into a text used for generating the image based on weighting indicating priority of reflecting the data in the image.

6. The image generation system according to claim 1, wherein
the at least one processor is further configured to execute the instructions to:
generate an image in which an image based on a face of the user is inserted into an image generated by the generation model based on the text.

7. The image generation system according to claim 1, wherein
the at least one processor is further configured to execute the instructions to:
convert behavior data regarding at least one of a timing of using the tourist facility, a predetermined area used in the tourist facility, and a predetermined attraction used in the tourist facility into a text.

8. The image generation system according to claim 1, wherein
the tourist facility is a theme park, and
the generation model generates an image based on at least one of an area of a theme park, an attraction, and a character.

9. The image generation system according to claim 1, wherein
the at least one processor is further configured to execute the instructions to:
in a case where the image is output, convert data regarding behavior performed after a time point at which the image is output into a text representing the behavior of the user or an environment at the time of the behavior.

10. The image generation system according to claim 1, wherein
the at least one processor is further configured to execute the instructions to:
output the generated image to a manufacturing system of a product related to the tourist facility.

11. An image generation method comprising:
acquiring data regarding behavior of a user in a tourist facility;
converting data regarding the behavior of the user into a text representing the behavior of the user or an environment at the time of the behavior based on a set rule;
generating an image based on the converted text using a generation model that generates an image related to the tourist facility based on the text; and
outputting the generated image.

12. A non-transitory recording medium recording an image generation program for causing a computer to execute processing of:
acquiring data regarding a behavior of a user in a tourist facility;
converting the data regarding the behavior of the user into a text representing the behavior of the user or an environment at the time of the behavior based on a set rule;
generating an image based on the converted text by using a generation model that generates an image related to the tourist facility based on the text; and
outputting the generated image.
